(19) United States
(12) Patent Application Publication
(10) Pub. No.: US 2025/0383900 A1
(43) Pub. Date: Dec. 18, 2025

(54) OUTBOUND PRIVATE LINK FRAMEWORK

(71) Applicant: Snowflake Inc., Bozeman, MT (US)

(72) Inventors: Abhi Mohnani, Glastonbury, CT (US); Bhanu Prakash, Kirkland, WA (US); Niranjan Kumar Sharma, Redmond, WA (US); Prasoon Shukla, Sunnyvale, CA (US); Ramana Rao S. Turlapati, Newark, CA (US); Yiren Zhou, Mountain View, CA (US)

(21) Appl. No.: 18/741,122

(22) Filed: Jun. 12, 2024

(51) Int. Cl. G06F 9/455

(52) U.S. Cl. CPC G06F 9/45558; G06F 2009/45595

(57) ABSTRACT

To provide outbound private link support for a multi-tenant data system with tenant isolation, a separate, dedicated virtual network is provided, referred to as private link (PL) virtual network. The PL virtual network may host a plurality of host interface endpoints and resource endpoints. A core virtual network and the PL virtual network may be peered together to work in conjunction. The private endpoints in the PL virtual network may then be connected to external systems using a private link without exposure to the public internet.

### TECHNICAL FIELD

The present disclosure generally relates to a multi-tenant network-based data systems, and, more specifically, to outbound private connectivity from the multi-tenant network-based data system to an external system.

### BACKGROUND

Data systems, such as database systems, may be provided through a cloud platform, which allows organizations and users to store, manage, and retrieve data from the cloud. Cloud data platforms are widely used for data storage and data access in computing and communication contexts. With respect to architecture, a cloud data platform could be an on-premises data platform, a network-based data platform (e.g., a cloud-based data platform), another type of architecture, or some combination thereof. With respect to type of data processing, a cloud data platform could implement online analytical processing (OLAP), online transactional processing (OLTP), a combination of the two, another type of data processing, or some combination thereof. Moreover, a cloud data platform could be or include a relational database management system (RDBMS) or one or more other types of database management systems.

Data engineers are focused primarily on building and maintaining data pipelines that transport data through different steps and put it into a usable state. The data engineering process encompasses the overall effort required to create data pipelines that automate the transfer of data from place to place and transform that data into a specific format for a certain type of analysis. In that sense, data engineering is an ongoing practice that involves collecting, preparing, transforming, and delivering data. A data pipeline helps automate these tasks so they can be reliably repeated.

### BRIEF DESCRIPTION OF THE DRAWINGS

Various ones of the appended drawings merely illustrate example embodiments of the present disclosure and should not be considered as limiting its scope.

FIG. 1 illustrates an example computing environment, according to some example embodiments.

FIG. 2 is a block diagram illustrating components of a compute service manager, according to some example embodiments.

FIG. 3 is a block diagram illustrating components of an execution platform, according to some example embodiments.

FIG. 4 is a block diagram of a computing environment conceptually illustrating an example software architecture executing a user-defined function (UDF) by a process running on an execution node of the execution platform, according to some example embodiments.

FIG. 5 is a block diagram illustrating subsystems of a network egress access control system, according to some example embodiments.

FIG. 6 illustrates an example framework for outbound private link connectivity for a multi-tenant network-based data system, according to some example embodiments.

FIG. 7 illustrates an example scenario of tenant isolation with outbound private endpoints, according to some example embodiments.

FIG. 8 illustrates a network flow diagram of a private network flow in a multi-tenant network-based data system, according to some example embodiments.

FIG. 9 shows a flow diagram for a method of managing a lifecycle of a private endpoint in a multi-tenant network-based data system, according to some example embodiments.

FIG. 10 illustrates a diagrammatic representation of a machine in the form of a computer system within which a set of instructions may be executed for causing the machine to perform any one or more of the methodologies discussed herein, in accordance with some embodiments of the present disclosure.

### DETAILED DESCRIPTION

The description that follows includes systems, methods, techniques, instruction sequences, and computing machine program products that embody illustrative embodiments of the disclosure. In the following description, for the purposes of explanation, numerous specific details are set forth in order to provide an understanding of various embodiments of the inventive subject matter. It will be evident, however, to those skilled in the art, that embodiments of the inventive subject matter may be practiced without these specific details. In general, well-known instruction instances, protocols, structures, and techniques are not necessarily shown in detail.

Users of a multi-tenant network-based data system may wish to connect to external systems, such as other cloud platforms. One technique to do so is to connect to the external system using a public network (e.g., internet). However, using a public connection can expose customer data and may be a security risk for sensitive information.

Some cloud platforms provide a private link service. However, those private connections are typically designed to connect to single tenant systems and not multi-tenant systems where resources are shared by multiple tenants. Accordingly, techniques for providing an outbound private connectivity for a multi-tenant data system are described herein. A multi-tenant data system can be provided on different cloud platforms and in different regions. For each region, the multi-tenant data system may be provided in a virtual network serving tenants/customers in that region, referred to as a core virtual network.

To provide outbound private link support, a separate, dedicated virtual network is provided, referred to as private link (PL) virtual network. The PL virtual network may host a plurality of host interface endpoints and resource endpoints. The core virtual network and the PL virtual network may be peered together to work in conjunction. The private endpoints in the PL virtual network may then be connected to external systems using a private link without exposure to the public internet. Therefore, private link features can be used in a multi-tenant data system with tenant isolation. Using a dedicated PL virtual network provides advantages such as maximizing the number private endpoints and allowing for independent scaling out of private endpoints with additional PL virtual networks.

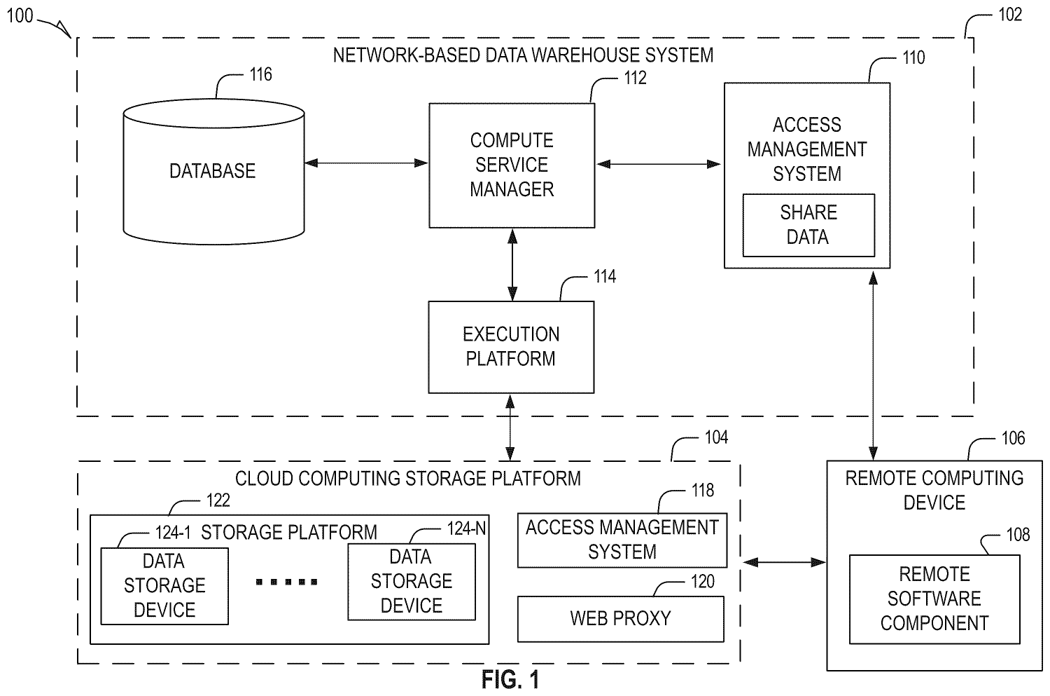

FIG. 1 illustrates an example shared data processing platform 100. To avoid obscuring the inventive subject matter with unnecessary detail, various functional components that are not germane to conveying an understanding of the inventive subject matter have been omitted from the figures. However, a skilled artisan will readily recognize that various additional functional components may be included as part of the shared data processing platform 100 to facilitate additional functionality that is not specifically described herein.

As shown, the shared data processing platform 100 comprises the network-based database system 102 (also referred to as multi-tenant network-based data system), a cloud computing storage platform 104 (e.g., a storage platform, an AWS® service, Microsoft Azure®, or Google Cloud Services®), and a remote computing device 106. The network-based database system 102 is a cloud database system used for storing and accessing data (e.g., internally storing data, accessing external remotely located data) in an integrated manner, and reporting and analysis of the integrated data from the one or more disparate sources (e.g., the cloud computing storage platform 104). The cloud computing storage platform 104 comprises a plurality of computing machines and provides on-demand computer system resources such as data storage and computing power to the network-based database system 102. While in the embodiment illustrated in FIG. 1, a data warehouse is depicted, other embodiments may include other types of databases or other data processing systems.

The remote computing device 106 (e.g., a user device such as a laptop computer) comprises one or more computing machines (e.g., a user device such as a laptop computer) that execute a remote software component 108 (e.g., browser accessed cloud service) to provide additional functionality to users of the network-based database system 102. The remote software component 108 comprises a set of machine-readable instructions (e.g., code) that, when executed by the remote computing device 106, cause the remote computing device 106 to provide certain functionality. The remote software component 108 may operate on input data and generates result data based on processing, analyzing, or otherwise transforming the input data. As an example, the remote software component 108 can be a data provider or data consumer that enables database tracking procedures.

The network-based database system 102 comprises an access management system 110, a compute service manager 112, an execution platform 114, and a database 116. The access management system 110 enables administrative users to manage access to resources and services provided by the network-based database system 102. Administrative users can create and manage users, roles, and groups, and use permissions to allow or deny access to resources and services. The access management system 110 can store shared data that securely manages shared access to the storage resources of the cloud computing storage platform 104 amongst different users of the network-based database system 102, as discussed in further detail below.

The compute service manager 112 coordinates and manages operations of the network-based database system 102. The compute service manager 112 also performs query optimization and compilation as well as managing clusters of computing services that provide compute resources (e.g., virtual warehouses, virtual machines, EC2 clusters). The compute service manager 112 can support any number of client accounts such as end users providing data storage and retrieval requests, system administrators managing the systems and methods described herein, and other components/devices that interact with compute service manager 112.

The compute service manager 112 is also coupled to database 116, which is associated with the entirety of data stored on the shared data processing platform 100. The database 116 stores data pertaining to various functions and aspects associated with the network-based database system 102 and its users.

In some embodiments, database 116 includes a summary of data stored in remote data storage systems as well as data available from one or more local caches. Additionally, database 116 may include information regarding how data is organized in the remote data storage systems and the local caches. Database 116 allows systems and services to determine whether a piece of data needs to be accessed without loading or accessing the actual data from a storage device. The compute service manager 112 is further coupled to an execution platform 114, which provides multiple computing resources (e.g., virtual warehouses) that execute various data storage and data retrieval tasks, as discussed in greater detail below.

Execution platform 114 is coupled to multiple data storage devices 124-1 to 124-N that are part of a cloud computing storage platform 104. In some embodiments, data storage devices 124-1 to 124-N are cloud-based storage devices located in one or more geographic locations. For example, data storage devices 124-1 to 124-N may be part of a public cloud infrastructure or a private cloud infrastructure. Data storage devices 124-1 to 124-N may be hard disk drives (HDDs), solid state drives (SSDs), storage clusters, Amazon S3 storage systems or any other data storage technology. Additionally, cloud computing storage platform 104 may include distributed file systems (such as Hadoop Distributed File Systems (HDFS)), object storage systems, and the like.

The execution platform 114 comprises a plurality of compute nodes (e.g., virtual warehouses). A set of processes on a compute node executes a query plan compiled by the compute service manager 112. The set of processes can include: a first process to execute the query plan; a second process to monitor and delete micro-partition files using a least recently used (LRU) policy, and implement an out of memory (OOM) error mitigation process; a third process that extracts health information from process logs and status information to send back to the compute service manager 112; a fourth process to establish communication with the compute service manager 112 after a system boot; and a fifth process to handle all communication with a compute cluster for a given job provided by the compute service manager 112 and to communicate information back to the compute service manager 112 and other compute nodes of the execution platform 114.

The cloud computing storage platform 104 also comprises an access management system 118 and a web proxy 120. As with the access management system 110, the access management system 118 allows users to create and manage users, roles, and groups, and use permissions to allow or deny access to cloud services and resources. The access management system 110 of the network-based database system 102 and the access management system 118 of the cloud computing storage platform 104 can communicate and share information so as to enable access and management of resources and services shared by users of both the network-based database system 102 and the cloud computing storage platform 104. The web proxy 120 handles tasks involved in accepting and processing concurrent API calls, including traffic management, authorization and access control, monitoring, and API version management. The web proxy 120 provides HTTP proxy service for creating, publishing, maintaining, securing, and monitoring APIs (e.g., REST APIs).

In some embodiments, communication links between elements of the shared data processing platform 100 are implemented via one or more data communication networks. These data communication networks may utilize any communication protocol and any type of communication medium. In some embodiments, the data communication networks are a combination of two or more data communication networks (or sub-Networks) coupled to one another. In alternative embodiments, these communication links are implemented using any type of communication medium and any communication protocol.

As shown in FIG. 1, data storage devices 124-1 to 124-N are decoupled from the computing resources associated with the execution platform 114. That is, new virtual warehouses can be created and terminated in the execution platform 114 and additional data storage devices can be created and terminated on the cloud computing storage platform 104 in an independent manner. This architecture supports dynamic changes to the network-based database system 102 based on the changing data storage/retrieval needs as well as the changing needs of the users and systems accessing the shared data processing platform 100. The support of dynamic changes allows network-based database system 102 to scale quickly in response to changing demands on the systems and components within network-based database system 102. The decoupling of the computing resources from the data storage devices 124-1 to 124-N supports the storage of large amounts of data without requiring a corresponding large amount of computing resources. Similarly, this decoupling of resources supports a significant increase in the computing resources utilized at a particular time without requiring a corresponding increase in the available data storage resources. Additionally, the decoupling of resources enables different accounts to handle creating additional compute resources to process data shared by other users without affecting the other users' systems. For instance, a data provider may have three compute resources and share data with a data consumer, and the data consumer may generate new compute resources to execute queries against the shared data, where the new compute resources are managed by the data consumer and do not affect or interact with the compute resources of the data provider.

Compute service manager 112, database 116, execution platform 114, cloud computing storage platform 104, and remote computing device 106 are shown in FIG. 1 as individual components. However, each of compute service manager 112, database 116, execution platform 114, cloud computing storage platform 104, and remote computing environment may be implemented as a distributed system (e.g., distributed across multiple systems/platforms at multiple geographic locations) connected by APIs and access information (e.g., tokens, login data). Additionally, each of compute service manager 112, database 116, execution platform 114, and cloud computing storage platform 104 can be scaled up or down (independently of one another) depending on changes to the requests received and the changing needs of shared data processing platform 100. Thus, in the described embodiments, the network-based database system 102 is dynamic and supports regular changes to meet the current data processing needs.

During typical operation, the network-based database system 102 processes multiple jobs (e.g., queries) determined by the compute service manager 112. These jobs are scheduled and managed by the compute service manager 112 to determine when and how to execute the job. For example, the compute service manager 112 may divide the job into multiple discrete tasks and may determine what data is needed to execute each of the multiple discrete tasks. The compute service manager 112 may assign each of the multiple discrete tasks to one or more nodes of the execution platform 114 to process the task. The compute service manager 112 may determine what data is needed to process a task and further determine which nodes within the execution platform 114 are best suited to process the task. Some nodes may have already cached the data needed to process the task (due to the nodes having recently downloaded the data from the cloud computing storage platform 104 for a previous job) and, therefore, be a good candidate for processing the task. Metadata stored in the database 116 assists the compute service manager 112 in determining which nodes in the execution platform 114 have already cached at least a portion of the data needed to process the task. One or more nodes in the execution platform 114 process the task using data cached by the nodes and, if necessary, data retrieved from the cloud computing storage platform 104. It is desirable to retrieve as much data as possible from caches within the execution platform 114 because the retrieval speed is typically much faster than retrieving data from the cloud computing storage platform 104.

As shown in FIG. 1, the shared data processing platform 100 separates the execution platform 114 from the cloud computing storage platform 104. In this arrangement, the processing resources and cache resources in the execution platform 114 operate independently of the data storage devices 124-1 to 124-N in the cloud computing storage platform 104. Thus, the computing resources and cache resources are not restricted to specific data storage devices 124-1 to 124-N. Instead, all computing resources and all cache resources may retrieve data from, and store data to, any of the data storage resources in the cloud computing storage platform 104.

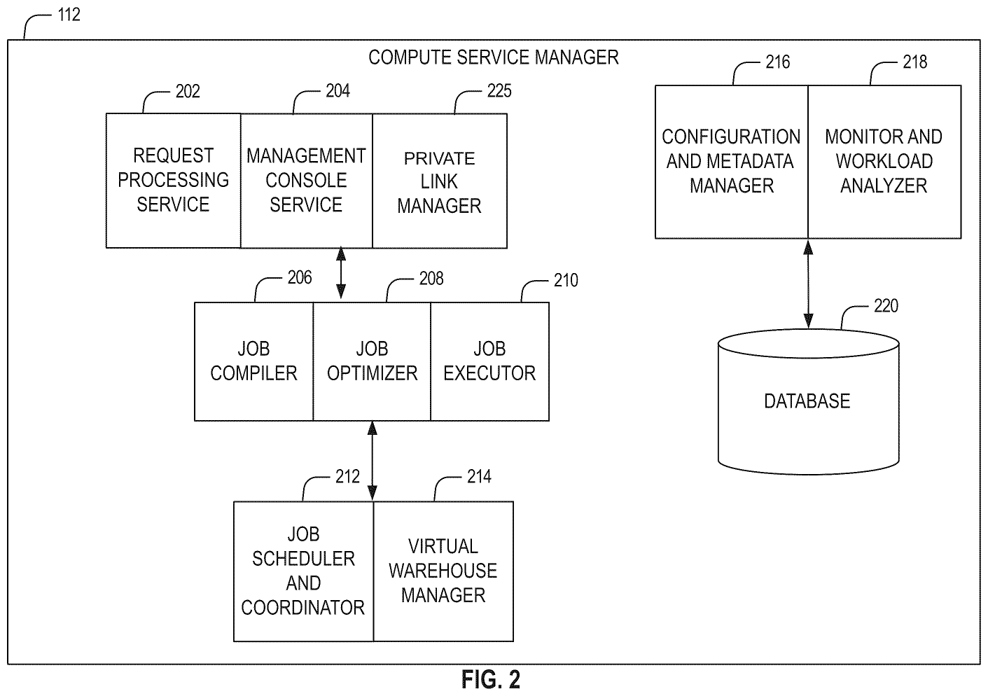

FIG. 2 is a block diagram illustrating components of the compute service manager 112, in accordance with some embodiments of the present disclosure. As shown in FIG. 2, a request processing service 202 manages received data storage requests and data retrieval requests (e.g., jobs to be performed on database data). For example, the request processing service 202 may determine the data necessary to process a received query (e.g., a data storage request or data retrieval request). The data may be stored in a cache within the execution platform 114 or in a data storage device in cloud computing storage platform 104. A management console service 204 supports access to various systems and processes by administrators and other system managers. Additionally, the management console service 204 may receive a request to execute a job and monitor the workload on the system.

The compute service manager 112 also includes a job compiler 206, a job optimizer 208, and a job executor 210. The job compiler 206 parses a job into multiple discrete tasks and generates the execution code for each of the multiple discrete tasks. The job optimizer 208 determines the best method to execute the multiple discrete tasks based on the data that needs to be processed. The job optimizer 208 also handles various data pruning operations and other data optimization techniques to improve the speed and efficiency of executing the job. The job executor 210 executes the execution code for jobs received from a queue or determined by the compute service manager 112.

A job scheduler and coordinator 212 sends received jobs to the appropriate services or systems for compilation, optimization, and dispatch to the execution platform 114. For example, jobs may be prioritized and processed in that prioritized order. In an embodiment, the job scheduler and coordinator 212 determines a priority for internal jobs that are scheduled by the compute service manager 112 with other “outside” jobs such as user queries that may be scheduled by other systems in the database but may utilize the same processing resources in the execution platform 114. In some embodiments, the job scheduler and coordinator 212 identifies or assigns particular nodes in the execution platform 114 to process particular tasks. A virtual warehouse manager 214 manages the operation of multiple virtual warehouses implemented in the execution platform 114. As discussed below, each virtual warehouse includes multiple execution nodes that each include a cache and a processor (e.g., a virtual machine, an operating system level container execution environment).

The compute service manager 112 includes a private link manager 225. As described in further detail below, the private link manager 225 may create, use, and manage private endpoints for private link communication with resources in external cloud platforms. The private endpoints may be hosted in a different virtual network than compute service manager 112, as described in further detail below.

Additionally, the compute service manager 112 includes a configuration and metadata manager 216, which manages the information related to the data stored in the remote data storage devices and in the local caches (i.e., the caches in execution platform 114). The configuration and metadata manager 216 uses the metadata to determine which data micro-partitions need to be accessed to retrieve data for processing a particular task or job. A monitor and workload analyzer 218 oversees processes performed by the compute service manager 112 and manages the distribution of tasks (e.g., workload) across the virtual warehouses and execution nodes in the execution platform 114. The monitor and workload analyzer 218 also redistributes tasks, as needed, based on changing workloads throughout the network-based database system 102 and may further redistribute tasks based on a user (e.g., “external”) query workload that may also be processed by the execution platform 114. The configuration and metadata manager 216 and the monitor and workload analyzer 218 are coupled to a data storage device 220. Data storage device 220 in FIG. 2 represent any data storage device within the network-based database system 102. For example, data storage device 220 may represent caches in execution platform 114, storage devices in cloud computing storage platform 104, or any other storage device.

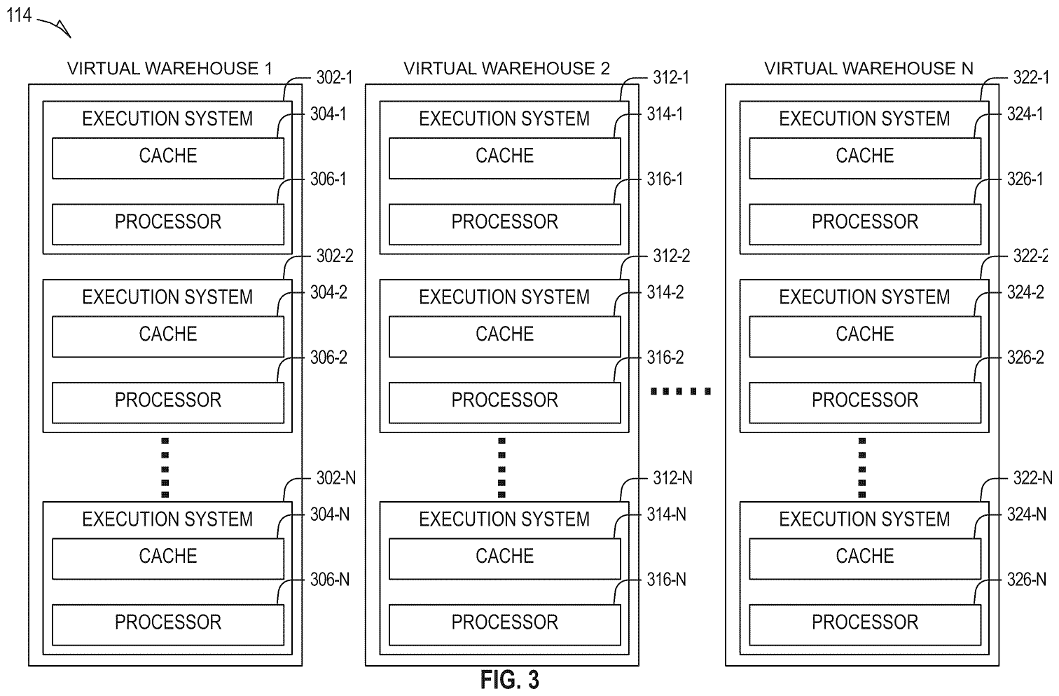

FIG. 3 is a block diagram illustrating components of the execution platform 114, in accordance with some embodiments of the present disclosure. As shown in FIG. 3, execution platform 114 includes multiple virtual warehouses, which are elastic clusters of compute instances, such as virtual machines. In the example illustrated, the virtual warehouses include virtual warehouse 1, virtual warehouse 2,and virtual warehouse n. Each virtual warehouse (e.g., EC2 cluster) includes multiple execution nodes (e.g., virtual machines) that each include a data cache and a processor. The virtual warehouses can execute multiple tasks in parallel by using the multiple execution nodes. As discussed herein, execution platform 114 can add new virtual warehouses and drop existing virtual warehouses in real time based on the current processing needs of the systems and users. This flexibility allows the execution platform 114 to quickly deploy large amounts of computing resources when needed without being forced to continue paying for those computing resources when they are no longer needed. All virtual warehouses can access data from any data storage device (e.g., any storage device in cloud computing storage platform 104).

Although each virtual warehouse shown in FIG. 3 includes three execution nodes, a particular virtual warehouse may include any number of execution nodes. Further, the number of execution nodes in a virtual warehouse is dynamic, such that new execution nodes are created when additional demand is present, and existing execution nodes are deleted when they are no longer necessary (e.g., upon a query or job completion).

Each virtual warehouse is capable of accessing any of the data storage devices 124-1 to 124-N shown in FIG. 1. Thus, the virtual warehouses are not necessarily assigned to a specific data storage device 124-1 to 124-N and, instead, can access data from any of the data storage devices 124-1 to 124-N within the cloud computing storage platform 104. Similarly, each of the execution nodes shown in FIG. 3 can access data from any of the data storage devices 124-1 to 124-N. For instance, the storage device 124-1 of a first user (e.g., provider account user) may be shared with a worker node in a virtual warehouse of another user (e.g., consumer account user), such that the other user can create a database (e.g., read-only database) and use the data in storage device 124-1 directly without needing to copy the data (e.g., copy it to a new disk managed by the consumer account user). In some embodiments, a particular virtual warehouse or a particular execution node may be temporarily assigned to a specific data storage device, but the virtual warehouse or execution node may later access data from any other data storage device.

In the example of FIG. 3, virtual warehouse 1 includes three execution nodes 302-1, 302-2, and 302-N. Execution node 302-1 includes a cache 304-1 and a processor 306-1. Execution node 302-2 includes a cache 304-2 and a processor 306-2. Execution node 302-N includes a cache 304-N and a processor 306-N. Each execution node 302-1, 302-2, and 302-N is associated with processing one or more data storage and/or data retrieval tasks. For example, a virtual warehouse may handle data storage and data retrieval tasks associated with an internal service, such as a clustering service, a materialized view refresh service, a file compaction service, a storage procedure service, or a file upgrade service. In other implementations, a particular virtual warehouse may handle data storage and data retrieval tasks associated with a particular data storage system or a particular category of data.

Similar to virtual warehouse 1 discussed above, virtual warehouse 2 includes three execution nodes 312-1, 312-2, and 312-N. Execution node 312-1 includes a cache 314-1 and a processor 316-1. Execution node 312-2 includes a cache 314-2 and a processor 316-2. Execution node 312-N includes a cache 314-N and a processor 316-N. Additionally, virtual warehouse 3 includes three execution nodes 322-1, 322-2, and 322-N. Execution node 322-1 includes a cache 324-1 and a processor 326-1. Execution node 322-2 includes a cache 324-2 and a processor 326-2. Execution node 322-N includes a cache 324-N and a processor 326-N.

In some embodiments, the execution nodes shown in FIG. 3 are stateless with respect to the data the execution nodes are caching. For example, these execution nodes do not store or otherwise maintain state information about the execution node, or the data being cached by a particular execution node. Thus, in the event of an execution node failure, the failed node can be transparently replaced by another node. Since there is no state information associated with the failed execution node, the new (replacement) execution node can easily replace the failed node without concern for recreating a particular state.

Although the execution nodes shown in FIG. 3 each include one data cache and one processor, alternative embodiments may include execution nodes containing any number of processors and any number of caches. Additionally, the caches may vary in size among the different execution nodes. The caches shown in FIG. 3 store, in the local execution node (e.g., local disk), data that was retrieved from one or more data storage devices in cloud computing storage platform 104 (e.g., S3 objects recently accessed by the given node). In some example embodiments, the cache stores file headers and individual columns of files as a query downloads only columns necessary for that query.

To improve cache hits and avoid overlapping redundant data stored in the node caches, the job optimizer 208 assigns input file sets to the nodes using a consistent hashing scheme to hash over table file names of the data accessed (e.g., data in database 116 or database 122). Subsequent or concurrent queries accessing the same table file will therefore be performed on the same node, according to some example embodiments.

As discussed, the nodes and virtual warehouses may change dynamically in response to environmental conditions (e.g., disaster scenarios), hardware/software issues (e.g., malfunctions), or administrative changes (e.g., changing from a large cluster to smaller cluster to lower costs). In some example embodiments, when the set of nodes changes, no data is reshuffled immediately. Instead, the least recently used replacement policy is implemented to eventually replace the lost cache contents over multiple jobs. Thus, the caches reduce or eliminate the bottleneck problems occurring in platforms that consistently retrieve data from remote storage systems. Instead of repeatedly accessing data from the remote storage devices, the systems and methods described herein access data from the caches in the execution nodes, which is significantly faster and avoids the bottleneck problem discussed above. In some embodiments, the caches are implemented using high-speed memory devices that provide fast access to the cached data. Each cache can store data from any of the storage devices in the cloud computing storage platform 104.

Further, the cache resources and computing resources may vary between different execution nodes. For example, one execution node may contain significant computing resources and minimal cache resources, making the execution node useful for tasks that require significant computing resources. Another execution node may contain significant cache resources and minimal computing resources, making this execution node useful for tasks that require caching of large amounts of data. Yet another execution node may contain cache resources providing faster input-output operations, useful for tasks that require fast scanning of large amounts of data. In some embodiments, the execution platform 114 implements skew handling to distribute work amongst the cache resources and computing resources associated with a particular execution, where the distribution may be further based on the expected tasks to be performed by the execution nodes. For example, an execution node may be assigned more processing resources if the tasks performed by the execution node become more processor-intensive. Similarly, an execution node may be assigned more cache resources if the tasks performed by the execution node require a larger cache capacity. Further, some nodes may be executing much slower than others due to various issues (e.g., virtualization issues, network overhead). In some example embodiments, the imbalances are addressed at the scan level using a file stealing scheme. In particular, whenever a node process completes scanning its set of input files, it requests additional files from other nodes. If the one of the other nodes receives such a request, the node analyzes its own set (e.g., how many files are left in the input file set when the request is received), and then transfers ownership of one or more of the remaining files for the duration of the current job (e.g., query). The requesting node (e.g., the file stealing node) then receives the data (e.g., header data) and downloads the files from the cloud computing storage platform 104 (e.g., from data storage device 124-1), and does not download the files from the transferring node. In this way, lagging nodes can transfer files via file stealing in a way that does not worsen the load on the lagging nodes.

Although virtual warehouses 1, 2, and n are associated with the same execution platform 114, the virtual warehouses may be implemented using multiple computing systems at multiple geographic locations. For example, virtual warehouse 1 can be implemented by a computing system at a first geographic location, while virtual warehouses 2 and n are implemented by another computing system at a second geographic location. In some embodiments, these different computing systems are cloud-based computing systems maintained by one or more different entities.

Additionally, each virtual warehouse is shown in FIG. 3 as having multiple execution nodes. The multiple execution nodes associated with each virtual warehouse may be implemented using multiple computing systems at multiple geographic locations. For example, an instance of virtual warehouse 1 implements execution nodes 302-1 and 302-2 on one computing platform at a geographic location and implements execution node 302-N at a different computing platform at another geographic location. Selecting particular computing systems to implement an execution node may depend on various factors, such as the level of resources needed for a particular execution node (e.g., processing resource requirements and cache requirements), the resources available at particular computing systems, communication capabilities of networks within a geographic location or between geographic locations, and which computing systems are already implementing other execution nodes in the virtual warehouse.

Execution platform 114 is also fault tolerant. For example, if one virtual warehouse fails, that virtual warehouse is quickly replaced with a different virtual warehouse at a different geographic location.

A particular execution platform 114 may include any number of virtual warehouses. Additionally, the number of virtual warehouses in a particular execution platform is dynamic, such that new virtual warehouses are created when additional processing and/or caching resources are needed. Similarly, existing virtual warehouses may be deleted when the resources associated with the virtual warehouse are no longer necessary.

In some embodiments, the virtual warehouses may operate on the same data in cloud computing storage platform 104, but each virtual warehouse has its own execution nodes with independent processing and caching resources. This configuration allows requests on different virtual warehouses to be processed independently and with no interference between the requests. This independent processing, combined with the ability to dynamically add and remove virtual warehouses, supports the addition of new processing capacity for new users without impacting the performance observed by the existing users.

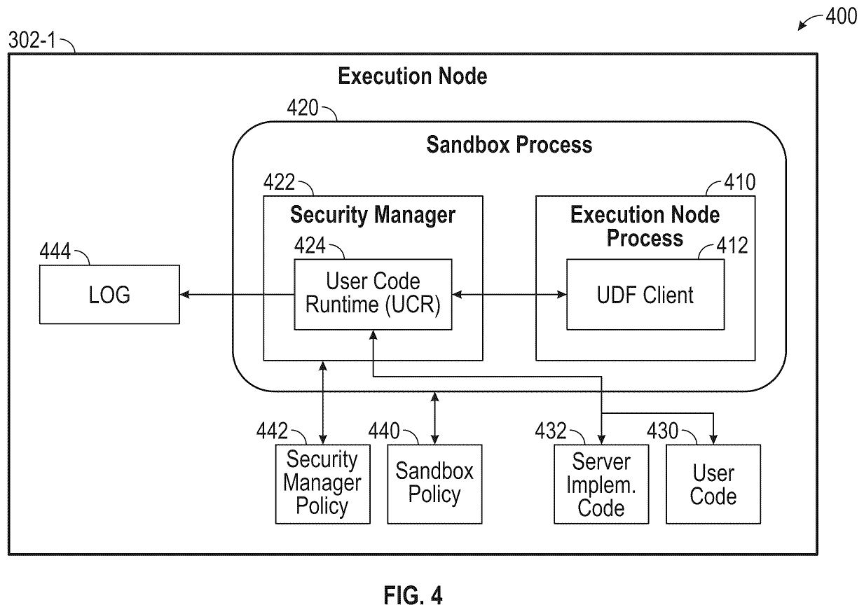

FIG. 4 is a computing environment 400 conceptually illustrating an example software architecture executing a user-defined function (UDF) by a process running on a given execution node of the execution platform 114 of FIG. 3, in accordance with some embodiments of the present disclosure.

As illustrated, the execution node 302-1 from the execution platform 114 includes an execution node process 410, which in an embodiment is running on the processor 306-1 and can also utilize memory from the cache 304-1 (or another memory device or storage). As mentioned herein, a “process” or “computing process” can refer to an instance of a computer program that is being executed by one or more threads by an execution node or execution platform.

As mentioned before, the compute service manager 112 validates communication from the execution platform 114 to validate that the content and context of that communication are consistent with the task(s) known to be assigned to the execution platform 114. For example, the execution platform 114 executing a query A is not allowed to request access to a particular data source (e.g., one of the storage devices in the cloud storage platform 104) that is not relevant to query A. In some examples, the execution node 302-1 may need to communicate with a second execution node (e.g., execution node 312-1), but the security mechanisms described herein can disallow communication with a third execution node (e.g., execution node 322-1). Moreover, any such illicit communication can be recorded (e.g., in a log 444 or other location). Further, the information stored on a given execution node is restricted to data relevant to the current query and any other data is unusable by destruction or encryption where the key is unavailable.

The execution node process 410 is executing a UDF client 412 in the example of FIG. 4. In some embodiments, the UDF client 412 is implemented to support UDFs written in a particular programming language such as JAVA, and the like. In some embodiments, the UDF client 412 is implemented in a different programming language (e.g., C or C++) than the user code 430, which can further improve security of the computing environment 400 by using a different codebase (e.g., one with the same or fewer potential security exploits).

User code 430 may be provided as a package, e.g., in the form of a JAR (JAVA archive) file, which includes code for one or more UDFs. Server implementation code 432, in an embodiment, is a JAR file that initiates a server which is responsible for receiving requests from the execution node process 410, assigning worker threads to execute user code, and returning the results, among other types of server tasks.

In some embodiments, an operation from a UDF (e.g., JAVA-based UDF) can be performed by a user code runtime 424 executing within a sandbox process 420. In some embodiments, the user code runtime 424 is implemented as a virtual machine, such as a JAVA virtual machine (JVM). Since the user code runtime 424 executes in a separate process relative to the execution node process 410, there is a lower risk of manipulating the execution node process 410. Results of performing the operation, among other types of information or messages, can be stored in a log 444 for review and retrieval. In some embodiments, the log 444 can be stored locally in memory at the execution node 302-1, or at a separate location such as the cloud storage platform 104.

Examples of the log 444 can include logging for observability and debuggability. Logging can be automatically configured to observe egress traffic using a logging mechanism with runtime-configurable verbosity levels. For example, use of an event output log or event output helper can allow for passing custom structs from the eBPF program to a performance event ring buffer along with an optional packet sample. In response, the execution platform worker can pull the logs from log 444 or other logs from the buffer and write to execution platform logs, as an example. This channel can be used to log, debug, sample, and/or push notifications for network policy violations and the like. For example, the event output log or helper can be configured to pass the data through a lockless memory mapped per-CPU performance ring buffer, which is significantly faster (e.g., more efficient) than default logging support in eBPF.

Additional examples of the log 444 or other logs of the network-based database system 102 can be used to provide clear and actionable feedback necessary for users if their UDF's packet has been blocked. With the logging mechanism, the cloud data platform 102 or component thereof can report details back to the user (e.g., which IP and port has been blocked or violated the account policy). Additionally, when an unauthorized DNS request has been blocked, the eBPF program can intercept the packet and report back which hostname it tried to access and enter such information into the log 444, which is valuable for helping customers to troubleshoot and debug their UDF.

Moreover, such results can be returned from the user code runtime 424 to the UDF client 412 utilizing a high-performance protocol (e.g., without serialization or deserialization of data, without memory copies; operates on record batches without having to access individual columns, records or cells; utilizes efficient remote procedure call techniques and network protocol(s) for data transfer) for data transfer (e.g., distributed datasets) that further provides authentication and encryption of the data transfer. In some embodiments, the UDF client 412 uses a data transport mechanism that supports a network transfer of columnar data between the user code runtime 424 (and vice-versa).

Security manager 422, in an example, can prevent completion of an operation from a given UDF by throwing an exception (e.g., if the operation is not permitted), or returns (e.g., doing nothing) if the operation is permitted. In some embodiments, the security manager 422 is implemented as a JAVA security manager object that allows applications to implement a security policy such as a security manager policy 442, and enables an application to determine, before performing a possibly unsafe or sensitive operation, what the operation is and whether it is being attempted in a security context that allows the operation to be performed. The security manager policy 442 can be implemented as a file with permissions that the user code runtime 424 is granted. The application (e.g., UDF executed by the user code runtime 424) therefore can allow or disallow the operation based at least in part on the security policy.

Sandbox process 420, in some embodiments, is a sub-process (or separate process) from the execution node process 410. A sub-process, in some embodiments, refers to a child process of a given parent process (e.g., in this example, the execution node process 410). The sandbox process 420, in an example, is a program that reduces the risk of security breaches by restricting the running environment of untrusted applications using security mechanisms such as namespaces and secure computing modes (e.g., using a system call filter to an executing process and all its descendants, thus reducing the attack surface of the kernel of a given operating system). Moreover, in an example, the sandbox process 420 is a lightweight process in comparison to the execution node process 410 and is optimized (e.g., closely coupled to security mechanisms of a given operating system kernel) to process a database query in a secure manner within the sandbox environment.

For example, the instance of a computer program can be instantiated by the execution platform 114. For example, the execution node 302-1 can be configured for instantiating a user code runtime to execute the code of the UDF and/or to create a runtime environment that allows the user's code to be executed. The user code runtime can include an access control process including an access control list, where the access control list includes authorized hosts and access usage rights or other types of allow lists and/or blocklists with access control information. Instantiating a sandbox process can determine whether the UDF is permitted and instantiating the user code runtime as a child process of the sandbox process, the sandbox process configured to execute the at least one operation in a sandbox environment.

In some embodiments, the sandbox process 420 can utilize a virtual network connection in order to communicate with other components within the subject system. A specific set of rules can be configured for the virtual network connection with respect to other components of the subject system. For example, such rules for the virtual network connection can be configured for a particular UDF to restrict the locations (e.g., particular sites on the Internet or components that the UDF can communicate) that are accessible by operations performed by the UDF. Thus, in this example, the UDF can be denied access to particular network locations or sites on the Internet.

The sandbox process 420 can be understood as providing a constrained computing environment for a process (or processes) within the sandbox, where these constrained processes can be controlled and restricted to limit access to certain computing resources.

Examples of security mechanisms can include the implementation of namespaces in which each respective group of processes executing within the sandbox environment has access to respective computing resources (e.g., process IDs, hostnames, user IDs, file names, names associated with network access, inter-process communication, and the like) that are not accessible to another group of processes (which may have access to a different group of resources not accessible by the former group of processes), other container implementations, and the like. By having the sandbox process 420 execute as a sub-process to the execution node process 410, in some embodiments, latency in processing a given database query can be substantially reduced (e.g., a reduction in latency by a factor of 10× in some instances) in comparison with other techniques that may utilize a virtual machine solution by itself.

As further illustrated, the sandbox process 420 can utilize a sandbox policy 440 to enforce a given security policy. The sandbox policy 440 can be a file with information related to a configuration of the sandbox process 420 and details regarding restrictions, if any, and permissions for accessing and utilizing system resources. Example restrictions can include restrictions to network access, or file system access (e.g., remapping file system to place files in different locations that may not be accessible, other files can be mounted in different locations, and the like). The sandbox process 420 restricts the memory and processor (e.g., CPU) usage of the user code runtime 424, ensuring that other operations on the same execution node can execute without running out of resources.

As mentioned above, the sandbox process 420 is a sub-process (or separate process) from the execution node process 410, which in practice means that the sandbox process 420 resides in a separate memory space than the execution node process 410. In an occurrence of a security breach in connection with the sandbox process 420 (e.g., by errant or malicious code from a given UDF), if arbitrary memory is accessed by a malicious actor, the data or information stored by the execution node process is protected.

Although the above discussion of FIG. 4 describes components that are implemented using JAVA (e.g., an object-oriented programming language), it is appreciated that the other programming languages (e.g., interpreted programming languages) are supported by the computing environment 400. In an embodiment, PYTHON is supported for implementing and executing UDFs in the computing environment 400. In this example, the user code runtime 424 can be replaced with a PYTHON interpreter for executing operations from UDFs (e.g., written in PYTHON) within the sandbox process 420.

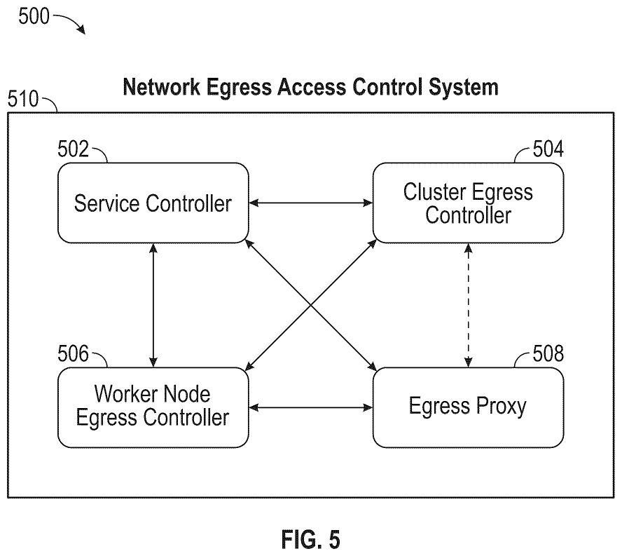

FIG. 5 is a block diagram 500 illustrating subsystems of a network egress access control system 510 (also referred to as “an egress control system”) with untrusted intermediaries, according to some example embodiments.

Example embodiments of the network egress access control system 510, may include four subsystems or sub-processes, including: a service controller 502, a cluster egress controller 504, a worker node egress controller 506, and an egress proxy 508. The subsystems interact to provide secure egress for the developer framework and programming environment container service, referred to as a framework and environment container service (FECS) or simply a “container service (CS).”

Examples of the network egress access control system 510 use cryptographic signatures as a key part of its egress control strategy by employing policy creation, cryptographic signatures, distribution of policies, and immediate validation that is efficient and secure. For example, the network egress access control system 510 starts with a trusted component, like the service controller 502, creating a set of egress policies. These policies, for example, specify the rules for what network traffic is allowed out of the system. These policies are then signed cryptographically, which means they are encoded in a way that ensures they have not been tampered with and are authentic. The signed policies are distributed to the parts of the network egress access control system 510 that will enforce them, such as an egress proxy 508.

When a container within the network egress access control system 510 wants to send data (e.g., a packet, information, etc.) to an external service (e.g., an egress request), the egress proxy 508 can immediately check the request against the signed policies. Because the policies are signed and contain all the necessary information (e.g., the “state”), the egress proxy 508 can validate the request on the spot without needing to ask another system for permission or additional information. This process is efficient because it does not require a round-trip communication with a central authority to validate each request. This process is secure because the cryptographic signatures prevent tampering, ensuring that only traffic that complies with the established rules is allowed to pass through. In some examples, the network egress access control system 510 design including multiple subsystems 502/504/506/508 provides that all the information needed to make a decision about network egress is embedded within the signed policies themselves, allowing for immediate and secure validation of egress requests.

The service controller 502 is a component of the network egress access control system 510 that schedules and manages execution of services. In some examples, the service controller 502 can take a customer account administrator's egress policies and translate the policies to cryptographically signed egress policies.

The cluster egress controller 504 acts as a liaison for egress policies pushed by the service controller. The worker node egress controller 506 handles validation of DNS requests from services and updates signed egress policies with specific worker virtual machine (VM) IP address and egress target IPs (as resolved by DNS requests). The worker node egress controller 506 includes multiple responsibilities, including: (1) to perform IP Address Management (IPAM) to ensure external access virtual Ethernets (veths) have node-level IP uniqueness, (2) to install and manage eBPF programs on customer pod veths, where these eBPF programs forward packets from the customer pods to the egress proxies, and (3) to forward policy registration requests to the egress proxies. In some examples, the worker node egress controller 506 can be considered part of a Container Network Interface (CNI) and acts as the liaison between the customer pod (e.g., container) and the egress proxies. In some examples, the worker node egress controller 506 is a central management entity responsible for making global decisions about the cluster and responding to cluster events.

An example embodiment of the network egress access control system 510 uses Kubernetes pods. Kubernetes is an open-source platform designed to automate the deployment, scaling, and operation of application containers across clusters of hosts. It will be understood by those having ordinary skill in the art that Kubernetes is used for exemplary purposes throughout the specification; however, other platforms and/or methods for handling containers may similarly be applied to the instant examples. A pod is the smallest deployable unit that can be created and managed, which is a group of one or more containers that are deployed together on the same host. Pods are commonly used to run instances of applications or services. According to examples, the use of “customer pod” or “customer container” can be considered interchangeably. For example, a customer container is an individual, lightweight, and portable unit of software that contains an application and all its dependencies, which are designed to run consistently across different computing environments (e.g., database systems, etc.). The customer container encapsulates an application's code, runtime, system tools, and the like, as well as provide for efficient resource usage and immutability.

In general terms, the egress controllers (e.g., cluster egress controller 504) runs on the control plane node. The worker node egress controller 506 runs as agents on all worker nodes and control plane nodes of the customer cluster; for example, the worker node egress controller runs on all nodes (e.g., both controller and worker). In some embodiments, the worker node egress controller is a node egress controller. The node egress daemon runs in host networking mode that allows it to manage the networking devices on the host. In some embodiments, the worker node egress controller 506 and/or the cluster egress controller 504 can run in host networking mode. Similarly, is it possible for the cluster egress controller to run anywhere other than on the control plane node, in some embodiments, when the node is trusted and the customer cannot break out of their container, then it can run anywhere without compromising security.

Moreover, egress controllers include initialization scripts (e.g., bootstrap process, setup script, etc.) that are executed prior to the main applications or service starting with the purpose of preparing the environment, performing initial configurations, and/or ensuring that certain prerequisites are met. In more specific examples, the initialization scripts serve a similar purpose to init containers in Kubernetes, which are used throughout the present disclosure for exemplary purposes and not limitation. The egress controller runs as a background process(es), such as an agent, daemon, or in Kubernetes terms, a DaemonSet, on all worker and control plane nodes of the customer cluster. It runs in host networking mode, which allows it to manage the networking devices on the host.

In some examples, where the network egress access control system 510 uses Kubernetes, the DaemonSet consists of an init container, whose sole responsibility is to copy the CNI binary into the correct location on the node, and a main container, which exposes APIs for initializing a pod and registering policies. An init container is a special type of container that is used in a Kubernetes pod. It is designed to run before the application containers are started and must complete successfully before the main containers of the pod are allowed to run. Init containers are useful for tasks that should be done before the application container starts. The init container is responsible for initializing the egress proxies in such a way that the customer pod can access any of its pre-configured IP policies immediately when it starts up. In some examples, the CNI waits for the policies to propagate before letting the container start (e.g., rather than having an init container). The init container, for example, can read the egress configuration map and perform a series of actions. For example, the init container can update the proxy list in the egress controller and pin any pre-configured IP policies by calling into the pinning service, and then register any successfully pinned policies on the egress proxies.

The worker node egress controller 506 is a component of the network egress access control system 510 that translates and encapsulates service DNS and network traffic to the cluster egress controller 504 (for DNS) and to the egress proxy 508 (for network traffic) so that service implementation does not need to understand how secure egress implementation works (e.g., the implementation appears to be transparent to customer services).

The egress proxy 508 is a component of the network egress access control system 510 that takes egress policies and egress network traffic from workers in order to validate the policies and implement the egress network rules described by the policies to allow or deny egress network traffic to external network resources. The egress proxy 508 also routes return traffic from those external resources back to the appropriate service. The egress proxy 508 also leverages a reconciler, which exposes APIs to components of the cloud data platform 102, such as the compute service manager 112. The reconciler can call to query the health of the egress proxy fleet. The egress proxy 508 acts as a gatekeeper for internet-bound traffic from FECS pods, enforcing egress policies on the outbound traffic. The egress proxy 508 can perform multiple responsibilities. The egress proxy 508 performs policy enforcement on incoming GENEVE encapsulated packets and performs SNAT on outbound traffic and DNAT on inbound traffic to proxy traffic between the sandbox and the internet destination. The egress proxies run as pods inside of the cloud data platform 102 application cluster. They run as a DaemonSet and are the only application running on a given node, so it has the full capacity of the node to use for network traffic. Moreover, like the egress controller, the egress proxy 508 runs in host networking to allow it to manage the networking devices on the host. The proxy consists of the exact same components as the egress controller (e.g., agent and eBPF code), however the main difference is that it does not perform IPAM or install eBPF code on veths. In some examples, it only has a GENEVE device that does decapsulation/policy enforcement and then can send the traffic directly to the internet.

IPAM refers to the mechanism for allocating IPs from a predefined subnet to be assigned to the veth devices created by both the main CNI (e.g., Cilium or Calico) and the custom CNI. For intra-cluster communications, the main CNI allocates IPs that are unique across the cluster. In some examples without these unique IP allocations, then it would be impossible to determine which pod to send a packet to when there are multiple pods on the network with the same IP address. The custom CNI, on the other hand, only needs to allocate IP addresses that are unique within the node. This is because, with a combination of SNAT and GENEVE tunneling, the egress controller and proxy can determine definitively which node a specific connection originated from, irrespective of the pod's IP address. As mentioned with reference to the CNI plugin, the custom CNI delegates IPAM to the egress controller running on the node, which tracks which IP addresses have already been allocated and allocates new IP addresses from a predefined subnet.

In some examples, for handling policy registration, the policy agent will maintain a policy map. The policy agent will then program an eBPF map with the entry format of {PolicyKey: 1}. The PolicyKey format allows the proxy to validate a packet is accessing an allowed destination and is originating from an allowed node. In some examples, these maps (e.g., configmaps) may have to lock to avoid races. When the egress proxy 508 receives a RegisterPolicies( ) request, it will perform a series of actions. First, the egress proxy 508 validates that the policy is of the correct type (e.g., pinned IP policy) and is correctly signed. Second, for each unique endpoint (e.g., dst IP+dst port+protocol), the egress proxy 508 will create or update the policy map entry in the policy agent's map, which is used by the agent for tracking TTL (“Time to Live”) to specify the duration (e.g., in seconds) that a DNS record is considered valid. The egress proxy 614, or component thereof, keeps track of the TTL values for DNS records or network policies to ensure that the information is current and that any expired entries are refreshed or removed as needed to maintain the integrity and accuracy of the network routing and policy enforcement. Next, it will add any new policies to the eBPF policy map.

When the egress proxy 508 receives an UnregisterPolicies( ) request, it will perform a series of deletions. First, the egress proxy 508 will delete all policies from the eBPF map for the given enforcement ID. Second, the egress proxy 508 will delete all policies from the policy agent's policy map. In some examples, periodically (e.g., on the order of <1 second), the policy agent will iterate over its policy map and identify any expired policies. It will then remove these policies by removing the corresponding entry in the userspace and eBPF policy maps. In some examples, this same logic for policy registration and deregistration can also be applied on the cluster egress controller 504.

In some examples, the network egress access control system 510 guarantees intra-node IP address uniqueness. For example, each IP address must be unique within the node, even between those IP addresses allocated by the main and custom CNIs. To guarantee this uniqueness, the main and custom CNIs will allocate IP addresses from different subnets. The two subnets, for example, would be 172.16.0.0/12 for the custom CNI and 10.224.x.x for the main CNI; for example, a CIDR range could be 10.244.0.0/16. However, in other examples, other ranges can be used. This would give the custom CNI the ability to allocate 1,048,572 unique IP addresses before exhausting the subnet range. In some examples, the main CNI is able to reuse previously allocated IP addresses; so, while some examples have to maintain IP address uniqueness across all nodes in the cluster, they will not exhaust their range assuming the number of concurrent pods does not exceed the number of IP addresses in its subnet range. Additionally, both of these subnet ranges must not conflict with the cloud data platform 102 services node subnet, which is typically the 10.0.0.0/8 range, for example and not limitation. In some examples, assigning node and pod IP addresses from the same subnet range will cause IP address conflicts.

It will be understood by those having ordinary skill in the art that GENEVE encapsulation is used for exemplary purposes throughout the specification; however, other encapsulation methods may similarly be applied to the instant examples.

As mentioned above, customers of the multi-tenant data system may want to connect to external systems, such as other cloud platforms. One technique to do so is to connect to the external system using a public network (e.g., internet). However, using a public connection can expose customer data and may be a security risk for sensitive information.

Some cloud platforms provide a private connection. However, those private connections are typically designed to connect to single tenant systems. That is, a private connection from an external platform would typically still be connected to a public connection of the multi-tenant data system. Next, techniques for providing an outbound private connectivity for a multi-tenant data system are described.

As described above, the multi-tenant data system can be provided on different cloud platforms and in different regions. For each region, the multi-tenant data system may be provided in a single virtual network serving tenants/customers in that region, referred to as a core virtual network. That is, a compute service manager 112 and execution platforms (XPs) 114 as described above may be provided using a single virtual network, referred to as core virtual network. A virtual network (also referred to as a VPC/VPN) is a software-defined network architecture that enables the creation and management of network resources, such as subnets, routing, and security policies, within a virtualized environment, facilitating communication between virtual machines and services as if they were on a physical network.

For outbound private link support, a separate, dedicated virtual network is provided, referred to as private link (PL) virtual network. The PL virtual network may host a plurality of host interface endpoints and resource endpoints. The data system's core virtual network and the PL virtual network may be peered together to work in conjunction. The private endpoints in the PL virtual network may then be connected to external systems using a private link without exposure to the public internet. Using a dedicated PL virtual network provides advantages such as maximizing the number private endpoints and allowing for independent scaling out of private endpoints with additional PL virtual networks.

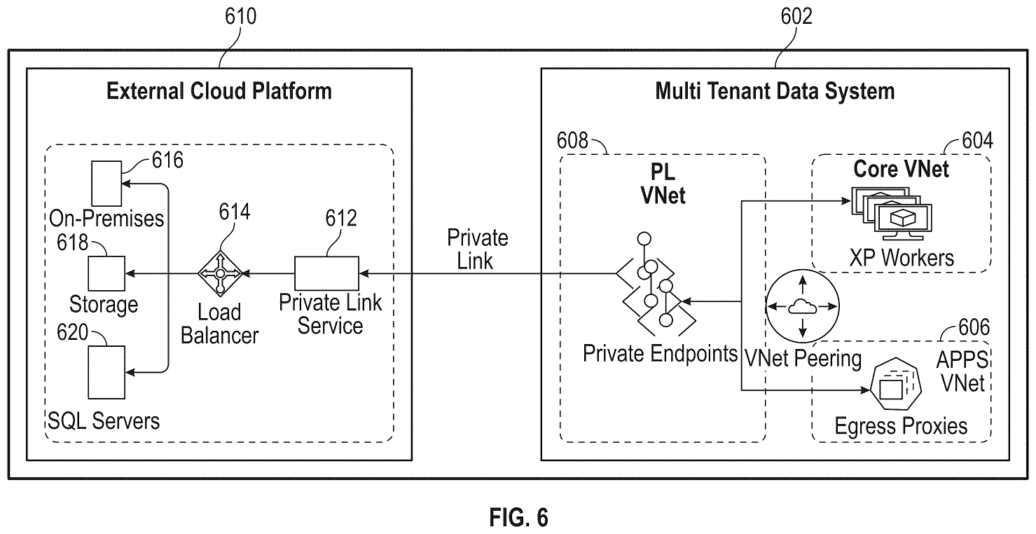

FIG. 6 illustrates an example framework for outbound private link connectivity for a multi-tenant network-based data system, according to some example embodiments. A multi-tenant data system 602 may be provided as described above with reference to FIGS. 1-3. The components of the multi-tenant data system 602, such as compute service managers, execution platforms, etc., may be provided in a core virtual network (Vnet) 604.

An Applications Vnet (APPS Vnet) 606 may also be provided. The APPs Vnet 606 may service applications. In some examples, the APPs Vnet 606 may host security services, such as egress proxies as described above. A PL Vnet 608 may be provided to host a plurality of private endpoints. For example, a respective private endpoint in the PL Vnet 608 may be connected to a resource in an external cloud platform 610 over a private link. Communications between components in the different virtual networks (core Vnet 604, APPS Vnet 606, PL Vnet 608) may be provided through peered communication. Virtual network peering connects two or more virtual networks, allowing them to communicate directly as if they were part of the same network. Components in different peered virtual networks may communicate through private IP addresses, maintaining low latency and high bandwidth.

The external cloud platform 610 may include a private link service 612, a load balancer 614, on-premises resources 616, storage 618, and servers 620 (e.g., SQL servers). The private connection may allow a tenant to transmit data from the multi-tenant data system 602 to a specified resource in the external cloud platform 610 over a private link without exposing data to the public internet and/or public network hops. The PL Vnet 608 may also provide tenant isolation in the multi-tenant system ensuring that one tenant data does not get intermingled with another tenant data when using the outbound private link. Therefore, private link features can be used in a multi-tenant data system with tenant isolation.

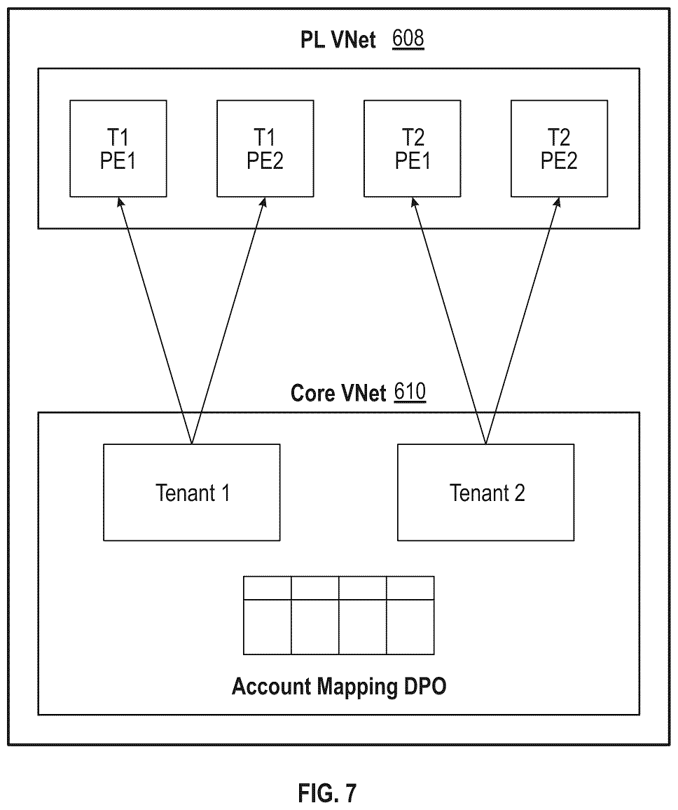

FIG. 7 illustrates an example scenario of tenant isolation with outbound private endpoints, according to some example embodiments. The PL Vnet 608 may include a plurality of tenants, such as tenant 1 and tenant 2. Tenant 1 may create two private endpoints in the PL Vnet 608: T1 PE1 and T1 PE2. Tenant 2 may create two private endpoints in the PL Vnet 608: T2 PE1 and T2 PE2. The private endpoints are dedicated per tenant and resource to an external cloud platform. That is, only tenant 1 can use T1 PE1 and T1 PE2 during their respective lifecycles, and no other tenant can use or access the endpoints dedicated to tenant 1. Likewise, only tenant 2 can use T2 PE1 and T2 PE2 during their respective lifecycles, and no other tenant can use or access the endpoints dedicated to tenant 2.

The lifecycle of the endpoints may be tracked using an account mapping data persistent object (DPO) stored in a metadata database (e.g., configuration and metadata manager 216). The account mapping DPO may include information such as account ID (tenant ID), endpoint type, private endpoint ID, PL resource ID, provider PL service name, and provider PL service resource ID.

As described in further detail below, tenants can create and manage lifecycles of private endpoints as needed. Sensitive (internal) attributes of the private endpoint, such as private ip address, vpce dns names, are accessible to only the tenant that created the private endpoint using runtime APIs in the PL Vnet 608. Packets that are routed to the private endpoints traverse through secure egress paths and are subject to egress policy checks, as described herein.

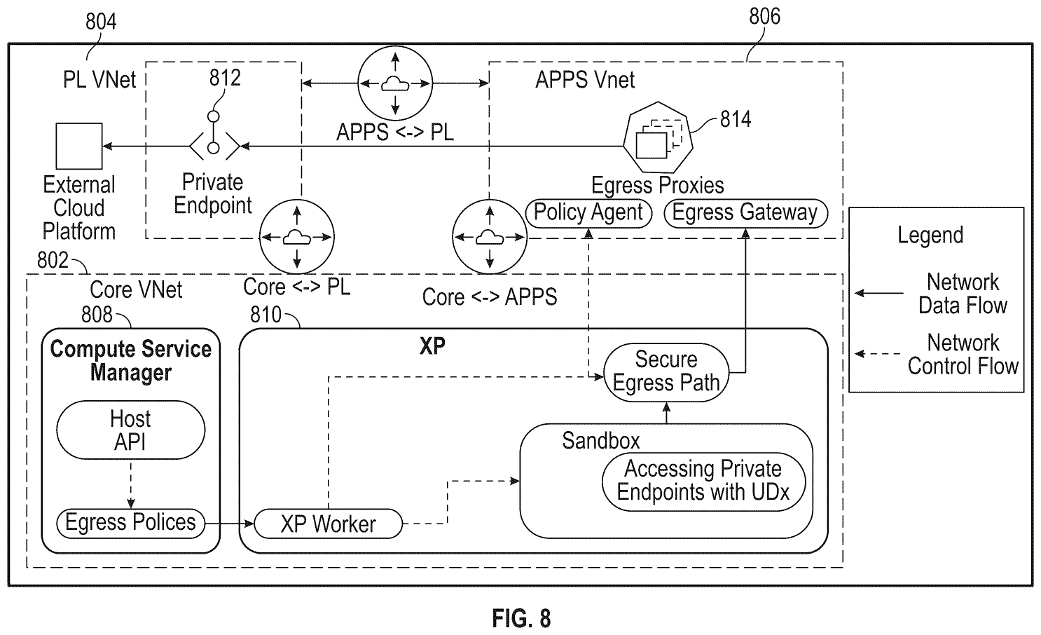

FIG. 8 illustrates a network flow diagram of a private network flow in a multi-tenant network-based data system, according to some example embodiments. As described above, the data system includes a core Vnet 802, PL Vnet 804, and Apps Vnet 806. The core Vnet 802 includes a compute service manager 808 and (one or more) XP 810, as described above.

The compute service manager 808 may utilize a PL API to create a private endpoint 812. As described above, the compute service manager 808 resides in the core Vnet 802, and the private endpoint 812 resides in the PL Vnet 804. The compute service manager 808 may also create an external access integration. The external access integration may include egress policy for using the private endpoint 812 enforced by egress proxies 814 in the APPS Vnet 806.

The compute service manager 808 may receive a query or other command requiring a private outbound connection to a resource in the external cloud platform. The compute service manager may query the PL API for the private endpoint corresponding to external cloud platform resource referenced in the query or other command. The relevant information may be stored in using an account mapping DPO stored in a metadata database, as described above. The PL API may return the identifier for the private endpoint previously created for the resource in the external cloud platform.

The compute service manager 808 may frame the query using a user defined function (UDF) for the external access integration. The compute service manager 808 may compile the UDF and egress policies. The compute service manager 808 may transmit the compiled logic to the XP 810 for execution during runtime. The compiled logic may also include an egress policy identifier.

An XP worker in the XP 810 may utilize a sandbox process, as described above, for executing the UDF. As described above, the UDF may include untrusted code, and, therefore, the XP 810 may utilize a sandbox to execute the UDF. The UDF execution results may be provided via a secure egress path to the APPS Vnet 806. The UDF execution results may include a transmission bound for the external cloud platform resource. The egress proxies 814 may receive the egress policy identifier generated by the compute service manager 808. The egress proxies 814 use the identifier generated by the compute service manager 808 because the compute service manager can only execute trusted code of the data system unlike the XP 810. The egress proxies 814 may check the policy to validate that the data from the XP 810 (e.g., UDF execution results) is meant for private IP address of the specified resource. The egress proxies 814 may then connect to the private endpoint 812 and transmit the outbound data to the identified resource in the external cloud platform. The outbound data exits the private endpoint 812 through a private link and connects to the resource in the external cloud platform.

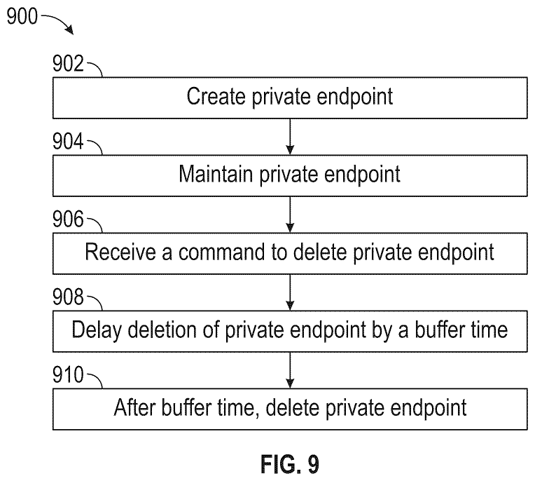

FIG. 9 shows a flow diagram for a method 900 of managing a lifecycle of a private endpoint in a multi-tenant network-based data system, according to some example embodiments. At operation 902, a compute service manager creates an endpoint based on the commands of a customer/user, as described above. The customer/user can specify to which a specified resource in an external cloud platform the private endpoint should connect. The private endpoint is given a unique identifier, such as an IP address, from a pool of private endpoint unique identifiers used by the data system.

At operation 904, the private endpoint is maintained and used by the data system. As described above, the private endpoint is hosted in a PL Vnet that is separate from the core Vnet of the data system. Also, as described above, details of the private endpoint may be managed in an account mapping DPO. The account mapping DPO may include information such as account ID (tenant ID), endpoint type, private endpoint ID, PL resource ID, provider PL service name, and provider PL service resource ID.

When the user executes an operation, such as query, referencing the specified resource in the external cloud platform, the account mapping DPO may be retrieved (e.g., queried) to retrieve the details of the private endpoint, which is then used for outbound communication over a private link, as described above. The account mapping enforces tenant isolation of the private endpoint in the multi-tenant network-based data system.

At operation 906, the data system receives a command to delete the private endpoint. For example, the customer/user may determine that it no longer needs to use the private link for communication with external resource and therefore can relinquish the private endpoint.

At operation 908, the data system delays the deletion of the private endpoint by a buffer time in response to the command to delete the private endpoint. For example, the account mapping DPO may be hidden but not deleted for the buffer time. That is, the private endpoint may not be able to be queried during the buffer time, but the private endpoint configuration is not deleted during the buffer time. Because the private endpoint is associated with a unique IP address, the data system may prevent potential overlap usage of the private IP address by delaying the deletion by a specified buffer time.

At operation 910, after the buffer time has expired, the data system may delete the account mapping DPO associated with the private endpoint and may return the unique identifier of the private endpoint to the pool of private endpoint unique identifiers used by the data system. That is, the unique identifier can then be used by another tenant.

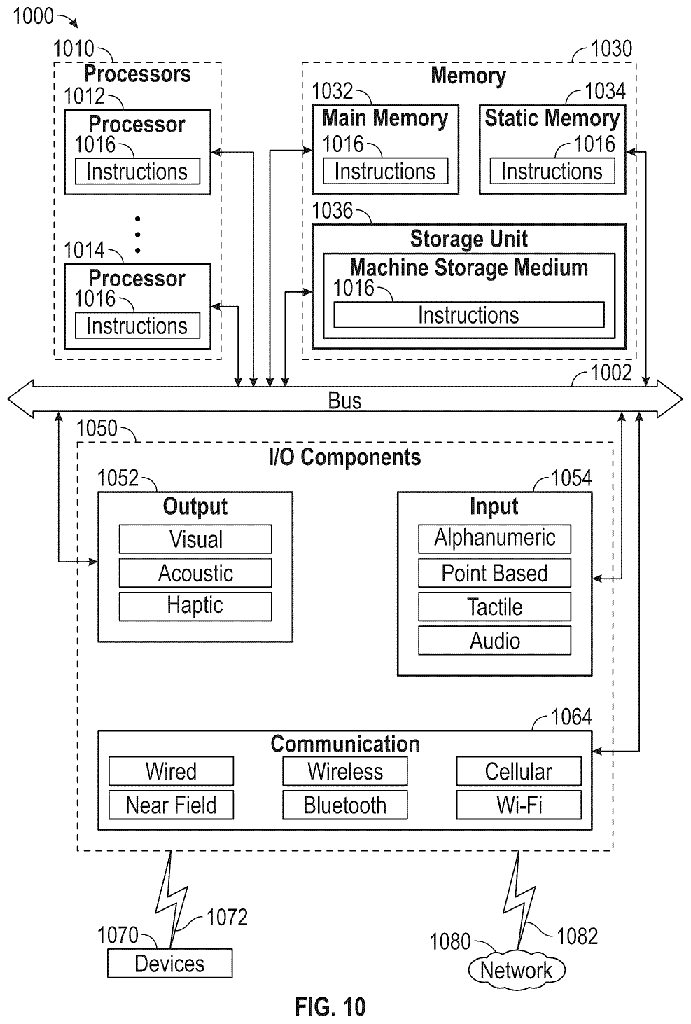

FIG. 10 illustrates a diagrammatic representation of a machine 1000 in the form of a computer system within which a set of instructions may be executed for causing the machine 1000 to perform any one or more of the methodologies discussed herein, according to an example embodiment. Specifically, FIG. 10 shows a diagrammatic representation of the machine 1000 in the example form of a computer system, within which instructions 1016 (e.g., software, a program, an application, an applet, an app, or other executable code) for causing the machine 1000 to perform any one or more of the methodologies discussed herein may be executed. For example, the instructions 1016 may cause the machine 1000 to execute any one or more operations of any one or more of the methods described herein. As another example, the instructions 1016 may cause the machine 1000 to implement portions of the data flows described herein. In this way, the instructions 1016 transform a general, non-programmed machine into a particular machine 1000 (e.g., the remote computing device 106, the access management system 118, the compute service manager 112, the execution platform 114, the access management system 110, the Web proxy 120, remote computing device 106) that is specially configured to carry out any one of the described and illustrated functions in the manner described herein.

In alternative embodiments, the machine 1000 operates as a standalone device or may be coupled (e.g., networked) to other machines. In a networked deployment, the machine 1000 may operate in the capacity of a server machine or a client machine in a server-client network environment, or as a peer machine in a peer-to-peer (or distributed) network environment. The machine 1000 may comprise, but not be limited to, a server computer, a client computer, a personal computer (PC), a tablet computer, a laptop computer, a netbook, a smart phone, a mobile device, a network router, a network switch, a network bridge, or any machine capable of executing the instructions 1016, sequentially or otherwise, that specify actions to be taken by the machine 1000. Further, while only a single machine 1000 is illustrated, the term “machine” shall also be taken to include a collection of machines 1000 that individually or jointly execute the instructions 1016 to perform any one or more of the methodologies discussed herein.

The machine 1000 includes processors 1010, memory 1030, and input/output (I/O) components 1050 configured to communicate with each other such as via a bus 1002. In an example embodiment, the processors 1010 (e.g., a central processing unit (CPU), a reduced instruction set computing (RISC) processor, a complex instruction set computing (CISC) processor, a graphics processing unit (GPU), a digital signal processor (DSP), an application-specific integrated circuit (ASIC), a radio-frequency integrated circuit (RFIC), another processor, or any suitable combination thereof) may include, for example, a processor 1012 and a processor 1014 that may execute the instructions 1016. The term “processor” is intended to include multi-core processors 1010 that may comprise two or more independent processors (sometimes referred to as “cores”) that may execute instructions 1016 contemporaneously. Although FIG. 10 shows multiple processors 1010, the machine 1000 may include a single processor with a single core, a single processor with multiple cores (e.g., a multi-core processor), multiple processors with a single core, multiple processors with multiple cores, or any combination thereof.

The memory 1030 may include a main memory 1032, a static memory 1034, and a storage unit 1036, all accessible to the processors 1010 such as via the bus 1002. The main memory 1032, the static memory 1034, and the storage unit 1036 store the instructions 1016 embodying any one or more of the methodologies or functions described herein. The instructions 1016 may also reside, completely or partially, within the main memory 1032, within the static memory 1034, within the storage unit 1036, within at least one of the processors 1010 (e.g., within the processor's cache memory), or any suitable combination thereof, during execution thereof by the machine 1000.

The I/O components 1050 include components to receive input, provide output, produce output, transmit information, exchange information, capture measurements, and so on. The specific I/O components 1050 that are included in a particular machine 1000 will depend on the type of machine. For example, portable machines such as mobile phones will likely include a touch input device or other such input mechanisms, while a headless server machine will likely not include such a touch input device. It will be appreciated that the I/O components 1050 may include many other components that are not shown in FIG. 10. The I/O components 1050 are grouped according to functionality merely for simplifying the following discussion and the grouping is in no way limiting. In various example embodiments, the I/O components 1050 may include output components 1052 and input components 1054. The output components 1052 may include visual components (e.g., a display such as a plasma display panel (PDP), a light emitting diode (LED) display, a liquid crystal display (LCD), a projector, or a cathode ray tube (CRT)), acoustic components (e.g., speakers), other signal generators, and so forth. The input components 1054 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

Communication may be implemented using a wide variety of technologies. The I/O components 1050 may include communication components 1064 operable to couple the machine 1000 to a network 1080 or devices 1070 via a coupling 1082 and a coupling 1072, respectively. For example, the communication components 1064 may include a network interface component or another suitable device to interface with the network 1080. In further examples, the communication components 1064 may include wired communication components, wireless communication components, cellular communication components, and other communication components to provide communication via other modalities. The devices 1070 may be another machine or any of a wide variety of peripheral devices (e.g., a peripheral device coupled via a universal serial bus (USB)). For example, as noted above, the machine 1000 may correspond to any one of the remote computing device 106, the access management system 118, the compute service manager 112, the execution platform 114, the access management system 110, the Web proxy 120, and the devices 1070 may include any other of these systems and devices.

The various memories (e.g., 1030, 1032, 1034, and/or memory of the processor(s) 1010 and/or the storage unit 1036) may store one or more sets of instructions 1016 and data structures (e.g., software) embodying or utilized by any one or more of the methodologies or functions described herein. These instructions 1016, when executed by the processor(s) 1010, cause various operations to implement the disclosed embodiments.

As used herein, the terms “machine-storage medium,” “device-storage medium,” and “computer-storage medium” mean the same thing and may be used interchangeably in this disclosure. The terms refer to a single or multiple storage devices and/or media (e.g., a centralized or distributed database, and/or associated caches and servers) that store executable instructions and/or data. The terms shall accordingly be taken to include, but not be limited to, solid-state memories, and optical and magnetic media, including memory internal or external to processors. Specific examples of machine-storage media, computer-storage media, and/or device-storage media include non-volatile memory, including by way of example semiconductor memory devices, e.g., erasable programmable read-only memory (EPROM), electrically erasable programmable read-only memory (EEPROM), field-programmable gate arrays (FPGAs), and flash memory devices; magnetic disks such as internal hard disks and removable disks; magneto-optical disks; and CD-ROM and DVD-ROM disks. The terms “machine-storage media,” “computer-storage media,” and “device-storage media” specifically exclude carrier waves, modulated data signals, and other such media, at least some of which are covered under the term “signal medium” discussed below.

In various example embodiments, one or more portions of the network 1080 may be an ad hoc network, an intranet, an extranet, a virtual private network (VPN), a local-area network (LAN), a wireless LAN (WLAN), a wide-area network (WAN), a wireless WAN (WWAN), a metropolitan-area network (MAN), the Internet, a portion of the Internet, a portion of the public switched telephone network (PSTN), a plain old telephone service (POTS) network, a cellular telephone network, a wireless network, a Wi-Fi® network, another type of network, or a combination of two or more such networks. For example, the network 1080 or a portion of the network 1080 may include a wireless or cellular network, and the coupling 1082 may be a Code Division Multiple Access (CDMA) connection, a Global System for Mobile communications (GSM) connection, or another type of cellular or wireless coupling. In this example, the coupling 1082 may implement any of a variety of types of data transfer technology, such as Single Carrier Radio Transmission Technology (1xRTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High-Speed Packet Access (HSPA), Worldwide Interoperability for Microwave Access (WiMAX), Long Term Evolution (LTE) standard, others defined by various standard-setting organizations, other long-range protocols, or other data transfer technology.

The instructions 1016 may be transmitted or received over the network 1080 using a transmission medium via a network interface device (e.g., a network interface component included in the communication components 1064) and utilizing any one of a number of well-known transfer protocols (e.g., hypertext transfer protocol (HTTP)). Similarly, the instructions 1016 may be transmitted or received using a transmission medium via the coupling 1072 (e.g., a peer-to-peer coupling) to the devices 1070. The terms “transmission medium” and “signal medium” mean the same thing and may be used interchangeably in this disclosure. The terms “transmission medium” and “signal medium” shall be taken to include any intangible medium that is capable of storing, encoding, or carrying the instructions 1016 for execution by the machine 1000, and include digital or analog communications signals or other intangible media to facilitate communication of such software. Hence, the terms “transmission medium” and “signal medium” shall be taken to include any form of modulated data signal, carrier wave, and so forth. The term “modulated data signal” means a signal that has one or more of its characteristics set or changed in such a manner as to encode information in the signal.

The terms “machine-readable medium,” “computer-readable medium,” and “device-readable medium” mean the same thing and may be used interchangeably in this disclosure. The terms are defined to include both machine-storage media and transmission media. Thus, the terms include both storage devices/media and carrier waves/modulated data signals.

The various operations of example methods described herein may be performed, at least partially, by one or more processors that are temporarily configured (e.g., by software) or permanently configured to perform the relevant operations. Similarly, the methods described herein may be at least partially processor-implemented. For example, at least some of the operations of the methods described herein may be performed by one or more processors. The performance of certain of the operations may be distributed among the one or more processors, not only residing within a single machine, but also deployed across a number of machines. In some example embodiments, the processor or processors may be located in a single location (e.g., within a home environment, an office environment, or a server farm), while in other embodiments the processors may be distributed across a number of locations.

Although the embodiments of the present disclosure have been described with reference to specific example embodiments, it will be evident that various modifications and changes may be made to these embodiments without departing from the broader scope of the inventive subject matter. Accordingly, the specification and drawings are to be regarded in an illustrative rather than a restrictive sense. The accompanying drawings that form a part hereof show, by way of illustration, and not of limitation, specific embodiments in which the subject matter may be practiced. The embodiments illustrated are described in sufficient detail to enable those skilled in the art to practice the teachings disclosed herein. Other embodiments may be used and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent, to those of skill in the art, upon reviewing the above description.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended; that is, a system, device, article, or process that includes elements in addition to those listed after such a term in a claim is still deemed to fall within the scope of that claim.

Described implementations of the subject matter can include one or more features, alone or in combination as illustrated below by way of example.
Example 1. A method comprising: transmitting, by a first device in a first virtual network in a multi-tenant network-based data system, a request for establishing a private endpoint for a first tenant of a plurality of tenants to connect to a resource in an external cloud platform outside of the multi-tenant network-based data system for outbound communication; hosting the private endpoint in a second virtual network in the multi-tenant network-based data system, the private endpoint being inaccessible by other tenants of the multi-tenant network-based data system during a lifecycle of the private endpoint; receiving, by the first device, a query referencing the resource; and executing at least a portion of the query using a private outbound connection from the multi-tenant network-based data system to the resource in the external cloud platform via the private endpoint.
Example 2. The method of example 1, further comprising: storing information for the private endpoint in a metadata record; and querying, by the first device, an application programming interface (API) of the second virtual network for the private endpoint in response to receiving the query referencing the resource.
Example 3. The method of any of examples 1-2, further comprising: framing, by the first device, the query using a user defined function (UDF); and compiling, by the first device, the UDF.
Example 4. The method of any of examples 1-3, further comprising: transmitting, by the first device, the compiled UDF to one or more execution platforms in the multi-tenant network-based data system, the compiled UDF including an egress policy identifier for an egress policy associated with the resource.
Example 5. The method of any of examples 1-4, further comprising: executing, by the one or more execution platforms, the UDF in a sandbox.
Example 6. The method of any of examples 1-5, further comprising: transmitting, by the one or more execution platforms, results of the UDF execution to an egress proxy provided in a third virtual network; and transmitting the egress policy identifier to the egress proxy.
Example 7. The method of any of examples 1-6, further comprising: validating, by the egress proxy, a destination for the results of the UDF execution as the resource based on the egress policy identifier generated by the first device.
Example 8. A system comprising: one or more processors of a machine; and a memory storing instructions that, when executed by the one or more processors, cause the machine to perform operations implementing any one of example methods 1 to 7.
Example 9. A machine-readable storage device embodying instructions that, when executed by a machine, cause the machine to perform operations implementing any one of example methods 1 to 7.

What is claimed is:

1. A method comprising:
transmitting, by a first device in a first virtual network in a multi-tenant network-based data system, a request for establishing a private endpoint for a first tenant of a plurality of tenants to connect to a resource in an external cloud platform outside of the multi-tenant network-based data system for outbound communication;
hosting the private endpoint in a second virtual network in the multi-tenant network-based data system, the private endpoint being inaccessible by other tenants of the multi-tenant network-based data system during a lifecycle of the private endpoint;
receiving, by the first device, a query referencing the resource; and
executing at least a portion of the query using a private outbound connection from the multi-tenant network-based data system to the resource in the external cloud platform via the private endpoint.

2. The method of claim 1, further comprising:
storing information for the private endpoint in a metadata record; and
querying, by the first device, an application programming interface (API) of the second virtual network for the private endpoint in response to receiving the query referencing the resource.

3. The method of claim 1, further comprising:
framing, by the first device, the query using a user defined function (UDF); and
compiling, by the first device, the UDF.

4. The method of claim 3, further comprising:
transmitting, by the first device, the compiled UDF to one or more execution platforms in the multi-tenant network-based data system, the compiled UDF including an egress policy identifier for an egress policy associated with the resource.

5. The method of claim 4, further comprising:
executing, by the one or more execution platforms, the UDF in a sandbox.

6. The method of claim 5, further comprising:
transmitting, by the one or more execution platforms, results of the UDF execution to an egress proxy provided in a third virtual network; and
transmitting the egress policy identifier to the egress proxy.

7. The method of claim 6, further comprising:
validating, by the egress proxy, a destination for the results of the UDF execution as the resource based on the egress policy identifier generated by the first device.

8. A machine-storage medium embodying instructions that, when executed by a machine, cause the machine to perform operations comprising:
transmitting, by a first device in a first virtual network in a multi-tenant network-based data system, a request for establishing a private endpoint for a first tenant of a plurality of tenants to connect to a resource in an external cloud platform outside of the multi-tenant network-based data system for outbound communication;
hosting the private endpoint in a second virtual network in the multi-tenant network-based data system, the private endpoint being inaccessible by other tenants of the multi-tenant network-based data system during a lifecycle of the private endpoint;
receiving, by the first device, a query referencing the resource; and
executing at least a portion of the query using a private outbound connection from the multi-tenant network-based data system to the resource in the external cloud platform via the private endpoint.

9. The machine-storage medium of claim 8, further comprising:
storing information for the private endpoint in a metadata record; and
querying, by the first device, an application programming interface (API) of the second virtual network for the private endpoint in response to receiving the query referencing the resource.

10. The machine-storage medium of claim 8, further comprising:
framing, by the first device, the query using a user defined function (UDF); and
compiling, by the first device, the UDF.

11. The machine-storage medium of claim 10, further comprising:
transmitting, by the first device, the compiled UDF to one or more execution platforms in the multi-tenant network-based data system, the compiled UDF including an egress policy identifier for an egress policy associated with the resource.

12. The machine-storage medium of claim 11, further comprising:
executing, by the one or more execution platforms, the UDF in a sandbox.

13. The machine-storage medium of claim 12, further comprising:
transmitting, by the one or more execution platforms, results of the UDF execution to an egress proxy provided in a third virtual network; and
transmitting the egress policy identifier to the egress proxy.

14. The machine-storage medium of claim 13, further comprising:
validating, by the egress proxy, a destination for the results of the UDF execution as the resource based on the egress policy identifier generated by the first device.

15. A system comprising:
at least one hardware processor; and
at least one memory storing instructions that, when executed by the at least one hardware processor, cause the at least one hardware processor to perform operations comprising:
transmitting, by a first device in a first virtual network in a multi-tenant network-based data system, a request for establishing a private endpoint for a first tenant of a plurality of tenants to connect to a resource in an external cloud platform outside of the multi-tenant network-based data system for outbound communication;
hosting the private endpoint in a second virtual network in the multi-tenant network-based data system, the private endpoint being inaccessible by other tenants of the multi-tenant network-based data system during a lifecycle of the private endpoint;
receiving, by the first device, a query referencing the resource; and
executing at least a portion of the query using a private outbound connection from the multi-tenant network-based data system to the resource in the external cloud platform via the private endpoint.

16. The system of claim 15, the operations further comprising:
storing information for the private endpoint in a metadata record; and
querying, by the first device, an application programming interface (API) of the second virtual network for the private endpoint in response to receiving the query referencing the resource.

17. The system of claim 15, the operations further comprising:
framing, by the first device, the query using a user defined function (UDF); and
compiling, by the first device, the UDF.

18. The system of claim 17, the operations further comprising:
transmitting, by the first device, the compiled UDF to one or more execution platforms in the multi-tenant network-based data system, the compiled UDF including an egress policy identifier for an egress policy associated with the resource.

19. The system of claim 18, the operations further comprising:
executing, by the one or more execution platforms, the UDF in a sandbox.

20. The system of claim 19, the operations further comprising:
transmitting, by the one or more execution platforms, results of the UDF execution to an egress proxy provided in a third virtual network; and
transmitting the egress policy identifier to the egress proxy.

21. The system of claim 20, the operations further comprising:
validating, by the egress proxy, a destination for the results of the UDF execution as the resource based on the egress policy identifier generated by the first device.
